(19) United States
(12) Patent Application Publication
(10) Pub. No.: US 2018/0016827 A1
(43) Pub. Date: Jan. 18, 2018

(54) UPPER TILT-IN DOUBLE HUNG WINDOW

(71) Applicant: Amesbury Group, Inc., Amesbury, MA (US)

(72) Inventor: Gary Newman, Valley Springs, SD (US)

(73) Assignee: Amesbury Group, Inc., Amesbury, MA (US)

(21) Appl. No.: 15/650,023

(22) Filed: Jul. 14, 2017

Related U.S. Application Data
(60) Provisional application No. 62/362,509, filed on Jul. 14, 2016.

(51) Int. Cl. E05C 17/64; E05D 15/48; E05D 15/22; E05D 13/00; E05C 21/00

(52) U.S. Cl. CPC E05D 13/08; E05D 15/22; E05D 13/1207; E05D 15/48; E05C 21/00; E05Y 2900/148

(57) ABSTRACT

A sash tilt system for an upper sash of a double hung window includes a mounting bracket sized and shaped to be fixed relative to a lower sash jamb pocket. A sleeve that is configured to be mounted on the upper sash, and a sash link including a first end and an opposite second end. The first end is rotatably coupled to the sleeve and the second end includes a post extending therefrom. The post is at least partially receivable within the mounting bracket such that the sash link is rotatable with respect to the mounting bracket and the sleeve when the upper sash tilts away from an upper sash jamb pocket.

### CROSS-REFERENCE TO RELATED APPLICATIONS

This application claims priority to and the benefit of U.S. Provisional Patent Application Ser. No. 62/362,509, filed on Jul. 14, 2016, the disclosure of which is hereby incorporated herein by reference in its entirety.

### INTRODUCTION

The upper sash in a double hung window system can be held in place by sash balances and by a sash lock. These double hung window systems restrict the upper sash to move in the vertical plane of the window. When the sash lock is released, the balances typically allow the upper sash to move down a distance approximately equal to the sash height, which provides for ventilation. However, in this position, the upper sash can be hard to close causing the sash lock to be difficult to re-engage, and rain also may easily enter the structure when the upper sash is open. Additionally, the window may not be secure when the sashes are unlocked or open, which may allow children to fall from, and intruders to enter through, the window.

### SUMMARY

In one aspect, the technology relates to a sash tilt system for an upper sash of a double hung window, the sash tilt system including: a mounting bracket sized and shaped to be fixed relative to a lower sash jamb pocket; a sleeve configured to be mounted on the upper sash; and a sash link including a first end and an opposite second end, wherein the first end is rotatably coupled to the sleeve and the second end includes a post extending therefrom, wherein the post is at least partially receivable within the mounting bracket such that the sash link is rotatable with respect to the mounting bracket and the sleeve when the upper sash tilts away from an upper sash jamb pocket.

In an example, the sash tilt system further includes a keeper link configured to rotatably secure the post at least partially within the mounting bracket. In another example, the sash tilt system further includes a spring balance assembly disposed within the upper sash jamb pocket configured to balance the upper sash. In yet another example, the spring balance assembly includes: an extension spring; an anchor bracket disposed on one end of the extension spring, the anchor bracket configured to secure within the upper sash jamb pocket; and a shoe disposed on an opposite end of the extension spring, the shoe configured to couple to the upper sash. In still another example, the sash link is substantially L-shaped. In an example, the sash tilt system further includes a motor coupled to the sash link, wherein the rotation of the sash link is driven by the motor.

In another aspect, the technology relates to a double hung window including: an upper sash disposed at an upper sash jamb pocket; a lower sash disposed at a lower sash jamb pocket; at least one sash tilt system configured to tilt the upper sash in relation to the upper sash jamb pocket, the at least one sash tilt system including: a mounting bracket fixed relative to the lower sash jamb pocket; a sleeve mounted to the upper sash; and a sash link extending between the mounting bracket and the sleeve, wherein the sash link is rotatable in relation to the mounting bracket and the sleeve when the upper sash tilts.

In an example, the sash link includes a post that is at least partially rotatably receivable within the mounting bracket. In another example, the double hung window further includes a keeper link configured to rotatably secure the post at least partially within the mounting bracket. In yet another example, the double hung window further includes at least one spring balance disposed within the upper sash jamb pocket. In still another example, the at least one spring balance includes: an anchor bracket secured within the upper sash jamb pocket; a shoe coupled to the upper sash; and an extension spring extending between the anchor bracket and the shoe. In an example, the extension spring is disposed within a spring sleeve. In another example, the sleeve is mounted on a top rail of the upper sash. In yet another example, the at least one sash tilt system includes a first sash tilt system disposed on a first side of the upper sash and a second sash tilt system disposed on a second side of the upper sash, and wherein the double hung window further includes: a torsion bar extending between the first tilt assembly and the second tilt assembly; and a motor configured to drive the torsion bar and tilt the upper sash. In still another example, the double hung window further includes a sash lock disposed on the lower sash.

In another aspect, the technology relates to a method of assembling a double hung window including: fixing a mounting bracket relative to a lower sash jamb pocket; mounting a sleeve having a sash link to an upper sash; positioning the upper sash and the sleeve adjacent to the mounting bracket; and coupling the sash link to the mounting bracket.

In an example, the method further includes securing the sash link to the mounting bracket via a keeper link. In another example, the method further includes installing a spring balance on the upper sash. In yet another example, installing the spring balance further includes: positioning an anchor bracket within an upper sash jamb pocket based on a weight of the upper sash; and securing the anchor bracket within the upper sash jamb pocket. In still another example, coupling the sash link to the mounting bracket further includes rotating the sash link towards the mounting bracket such that a post is at least partially received therein.

### BRIEF DESCRIPTION OF THE DRAWINGS

There are shown in the drawings embodiments that are presently preferred, it being understood, however, that the invention is not limited to the precise arrangements and configurations shown.

FIGS. 1A and 1B are front and back perspective views of an exemplary double hung window in a closed position.

FIG. 1C is a top view of the double hung window in the closed position.

FIG. 1D is a cross-sectional view of the double hung window in the closed position taken along line 1D shown in FIG. 1C.

FIGS. 2A and 2B are front and back perspective views of the double hung window in a tilted position.

FIG. 2C is a top view of the double hung window in the tilted position.

FIG. 2D is a cross-sectional view of the double hung window in the tilted position taken along line 2D shown in FIG. 2C.

FIG. 3 is a perspective view of an exemplary sash tilt system for the double hung window.

FIG. 4 is a perspective view of an exemplary mounting bracket of the sash tilt system shown in FIG. 3.

FIG. 5 is a bottom perspective view of the sash tilt system shown in FIG. 3.

FIGS. 6A-6C are perspective views of the sash tilt system shown in FIG. 3 in a closed position, a middle position, and a tilted position, respectively.

FIG. 7 is a perspective view of an exemplary spring balance assembly for the double hung window.

FIG. 8 is a flowchart illustrating a method of operating a double hung window.

FIG. 9 is a schematic perspective view of another sash tilt system.

FIG. 10 is a flowchart illustrating a method of assembling a double hung window.

### DETAILED DESCRIPTION OF THE INVENTION

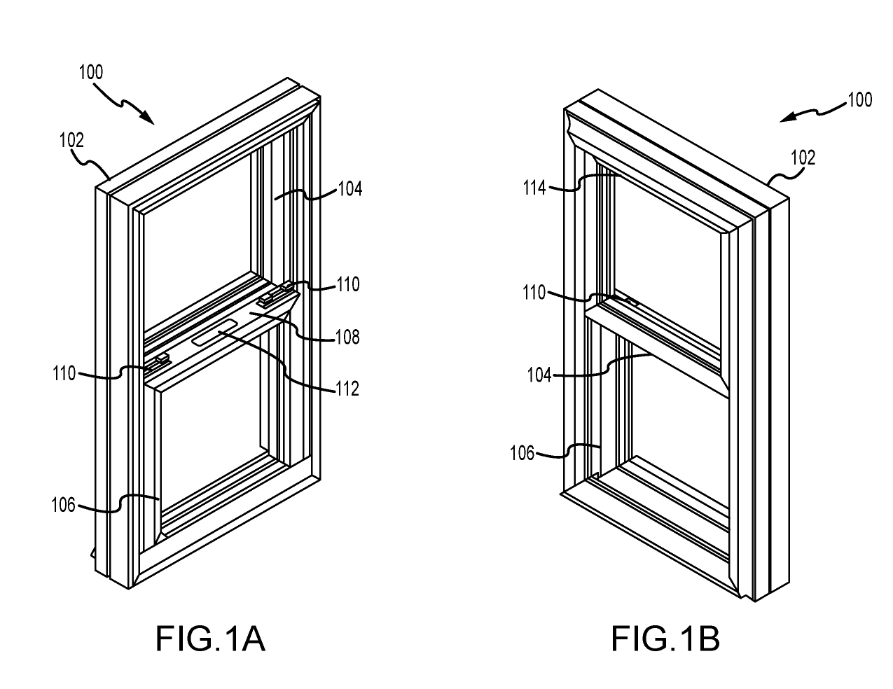

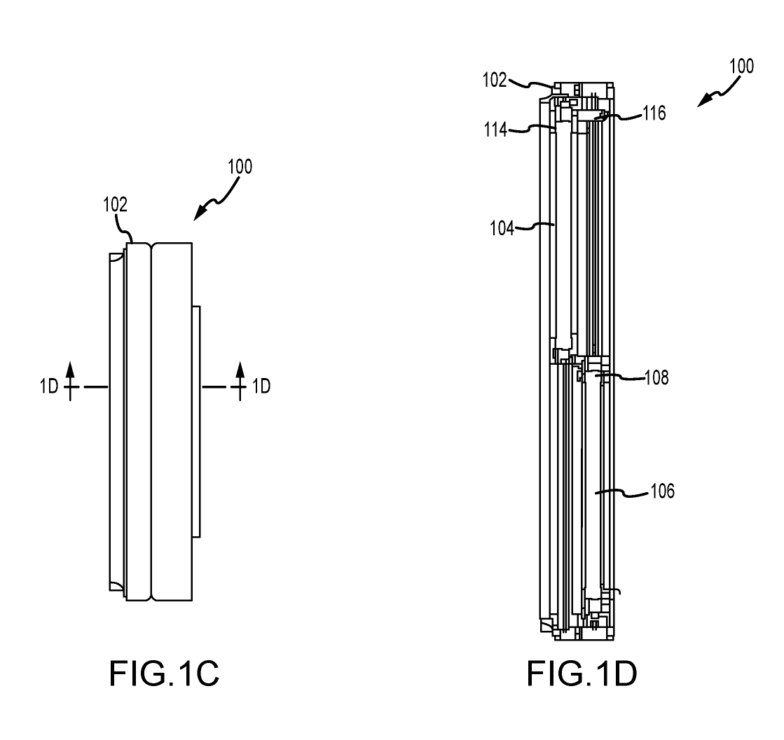

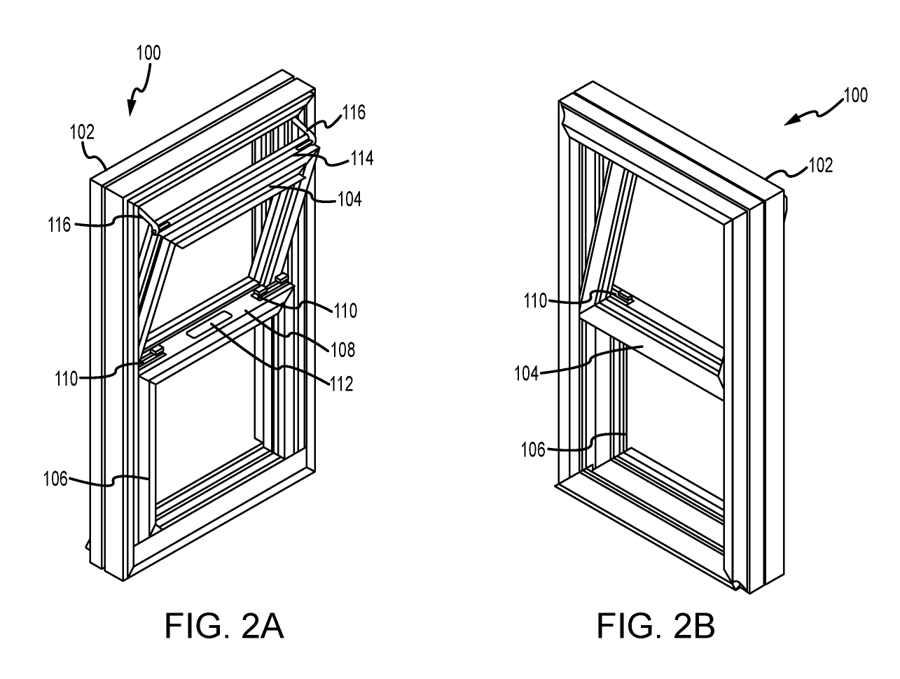

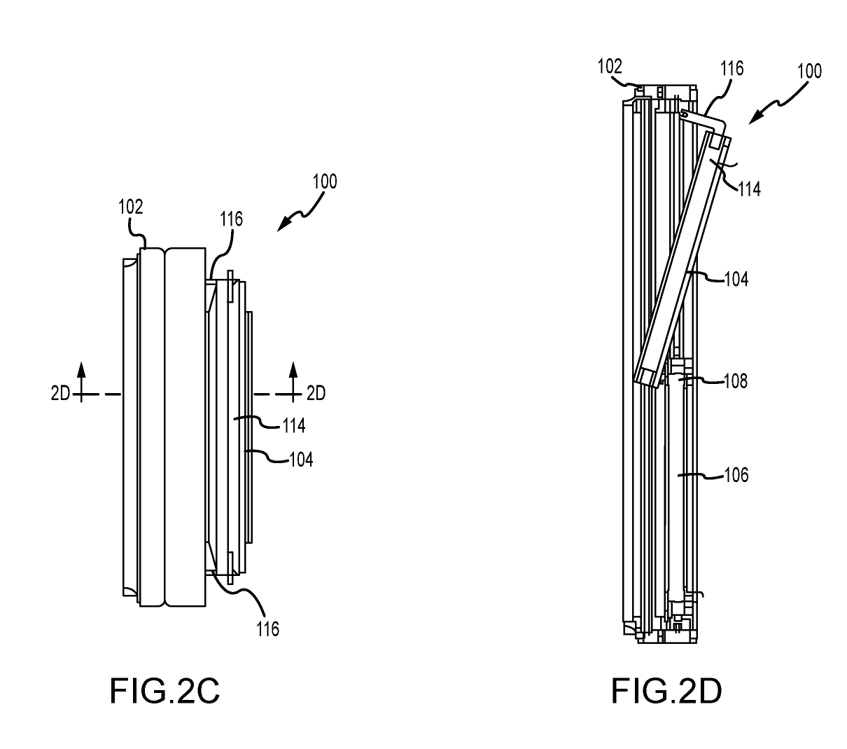

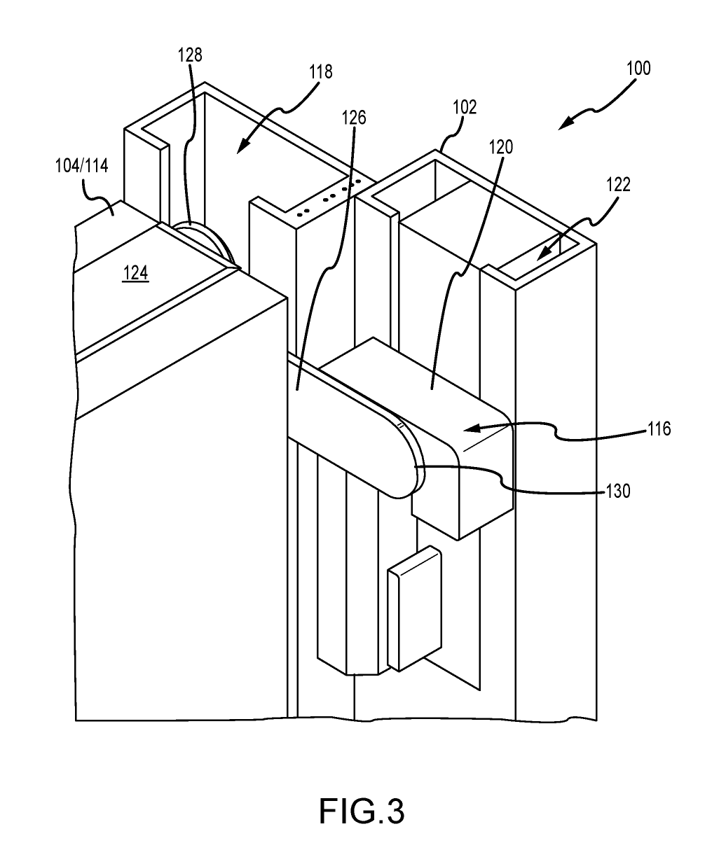

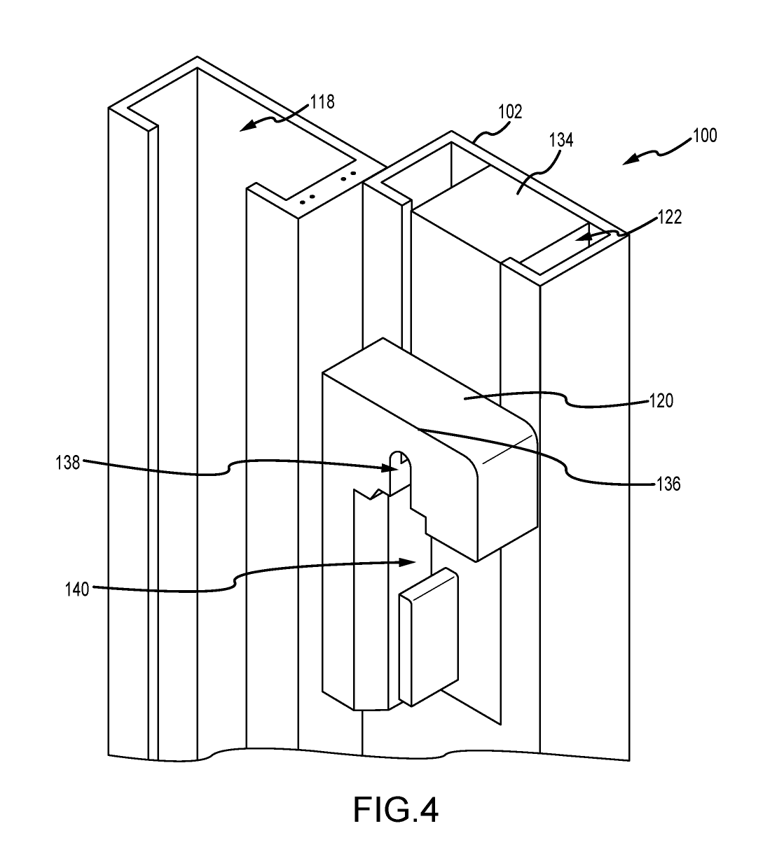

FIGS. 1A and 1B are front and back perspective views of an exemplary double hung window 100 in a closed position. FIG. 1C is a top view of the double hung window 100 in the closed position. FIG. 1D is a cross-sectional view of the double hung window 100 in the closed position taken along line 1D (shown in FIG. 1C). Referring concurrently to FIGS. 1A-1D, the double hung window 100 includes a window jamb 102 in which an upper sash 104 and a lower sash 106 are disposed. The lower sash 106 may slide vertically up and down within the window jamb 102 so as to open and close the window 100. At a top rail 108, the lower sash 106 may include one or more tilt latches 110 that enable the lower sash 106 to tilt in relation to the window jamb 102 so that the lower sash 106 may be cleaned. Additionally, a sash lock 112 is positioned on the top rail 108 for locking the lower sash 106 in the closed position relative to the upper sash 104. The upper sash 104 is positioned above the lower sash 106 within the window jamb 102 and also includes a top rail 114. A sash tilt system 116 extends from the top rail 114 to the window jamb 102 and enables the upper sash 104 to tilt in relation to the window jamb 102 and provide ventilation, as illustrated in FIGS. 2A-2D. In the closed position, the upper sash 104 is fully disposed within the window jamb 102 and is supported by sash balances (not shown).

FIGS. 2A and 2B are front and back perspective views of the double hung window 100 in a tilted position. FIG. 2C is a top view of the double hung window 100 in the tilted position. FIG. 2D is a cross-sectional view of the double hung window 100 in the tilted position taken along line 2D (shown in FIG. 2C). Referring concurrently to FIGS. 2A-2D, the upper sash 104 is pivoted relative to the window jamb 102 so that the upper sash 104 is in the tilted position and outside of the window jamb 102 for ventilation and/or cleaning. In the example, the sash tilt system 116 is positioned on either side of the upper sash 104. In alternative examples, a single sash tilt system 116 may be used on the upper sash 104.

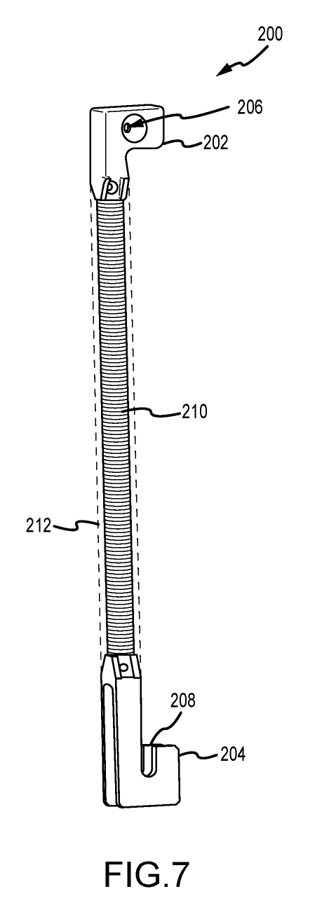

In operation, and as described in more detail below, when the sash lock 112 is disengaged to open the lower sash 106, the upper sash 104 is supported by the sash balances (not shown), which supports the weight of the upper sash 104, so as to not fall within the window jamb 102. The sash tilt system 116 allows the top rail 114 of the upper sash 104 to move in an arcuate path (e.g., a partial circle) from the fully-closed position to the tilted position. During the tilting of the top rail 114, the sash balance is configured to extend with a relatively short travel distance so that the top rail 114 can move along the arcuate path. However, the lifting forces of the sash balance are such that the upper sash 104 is returns to the top of the window jamb 102 once in the tilted position. For example, the sash balances may provide balance greater than 100% of the sash weight such that the upper sash 104 is positioned at the top of the window jamb 102 in both the closed and the tilted positions. Thus, the sash balance forces the upper sash 104 into the top most position (e.g., closed and tilted) and the sash tilt system 116 enables the upper sash 104 to be maintained in the tilted position so that the sash lock 112 may be engaged in both the closed and the tilted positions and lock the double hung window 100 even when the window 100 is in the tilted position. The sash balance is described in further detail below in reference to FIG. 7.

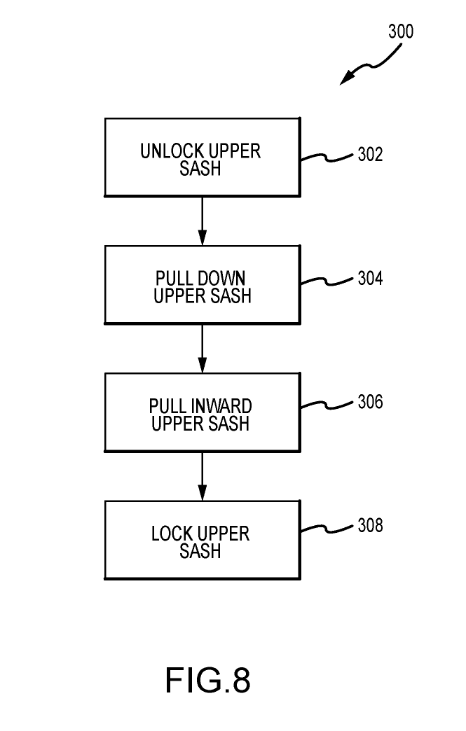

When compared to a standard double hung upper sash, the force required to open and close the pivoting upper sash 104 is less because the sash balance fully supports the weight of the sash, thus allowing a very heavy upper sash to be accommodated. The sash balance also enables only short travel distances within the window jamb 102, so that the vertical travel of the upper sash 104 is a reduced, as compared to a traditional hung window sash that slides in the frame. Accordingly, a weatherstrip (not shown) is engaged only in the closed position and sliding contact thereagainst is reduced due to the pivoting nature of the window as it tilts. This results in less wear on the weatherstrip. Additionally, when the upper sash 104 is pivoted to the tilted position, the tilting provides ventilation and resists the intrusion of rain, due to the inward tilt of the upper sash 104. The sash lock 112 can also be re-engaged when the upper sash 104 is in the tilted position, thus reducing the safety concern of children falling therethrough and the security concern of an unauthorized intrusion. Although the components depicted herein are manually operated, a powered system is also contemplated as described further below. The two sash tilt systems 116 described below may be connected together with a torsion bar and an electric motor can be used to rotate the upper sash 104 through a desired range of motion to achieve the tilted condition, as described further below in reference to FIG. 8.

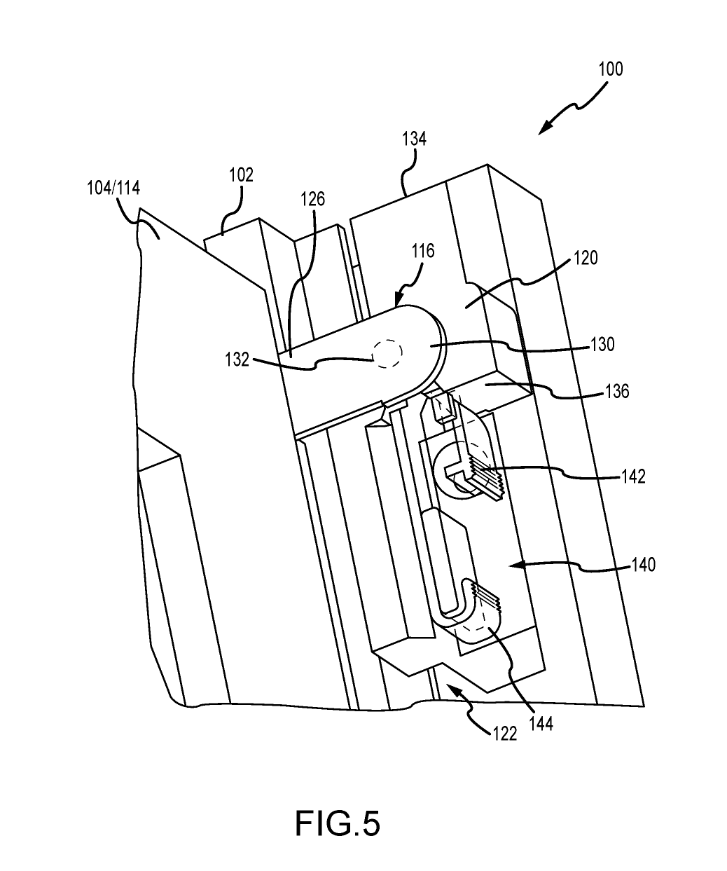

FIG. 3 is a perspective view of the exemplary sash tilt system 116 for the double hung window 100, depicted with the header of the window jamb 102 removed. In the example, the upper sash 104 is depicted in the closed potion and mounted within the window jamb 102 by the sash balance (not shown) positioned within a jamb pocket 118 for the upper sash 104. The sash tilt system 116 includes a mounting bracket 120 that is sized and shaped to be fixed relative to a jamb pocket 122 of the window jamb 102 for the lower sash 106. The mounting height of the mounting bracket 120 is towards the top of the lower sash jamb pocket 122 such that the sash balance can support the upper sash 104 when in the closed and tilted positions.

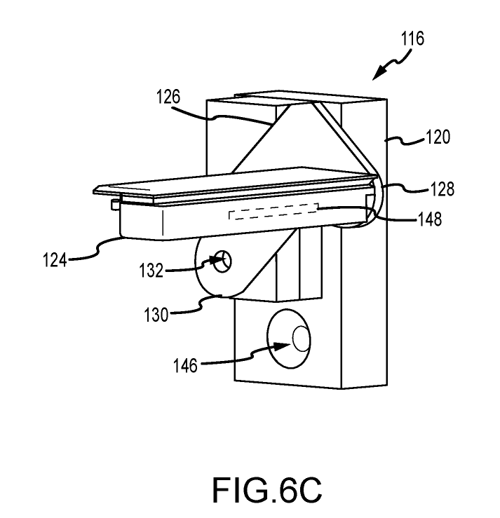

The sash tilt system 116 also includes a sleeve 124 that is at least partially recessed within the top rail 114 of the upper sash 104. In one example, the sleeve 124 may be disposed in a cutout previously occupied by a tilt latch. In an alternative example, the sleeve 124 may be surface mounted on the upper sash 104. As such, components of the sash tilt system 116 may be utilized in retrofit applications. Extending between the mounting bracket 120 and the sleeve 124 is a sash link 126. In the example, the sash link 126 is an L-shaped plate or bar approximately 2 inches long that fits between the upper sash 104 and the window jamb 102 and that includes a first end 128 and an opposite second end 130. The first end 128 is rotatably coupled to the sleeve 124. For example, the first end 128 includes a post 148 (shown in FIGS. 6A-6C) extending from the sash link 126 so that the post 148 is rotatably received at least partially within the sleeve 124 and the sash link 126 can rotate relative to the upper sash 104. The second end 130 is rotatably coupled to the mounting bracket 120. For example, the second end 130 also includes a post 132 (shown in FIGS. 6A-6C) extending from the sash link 126 so that the post 132 is rotatably received at least partially within the mounting bracket 120 and the sash link 126 can rotate relative to the window jamb 102. As such, both posts 132, 148 are configured to rotate within either the sleeve 124 or the mounting bracket 120 as the upper sash 104 pivots between the closed and tilted positions.

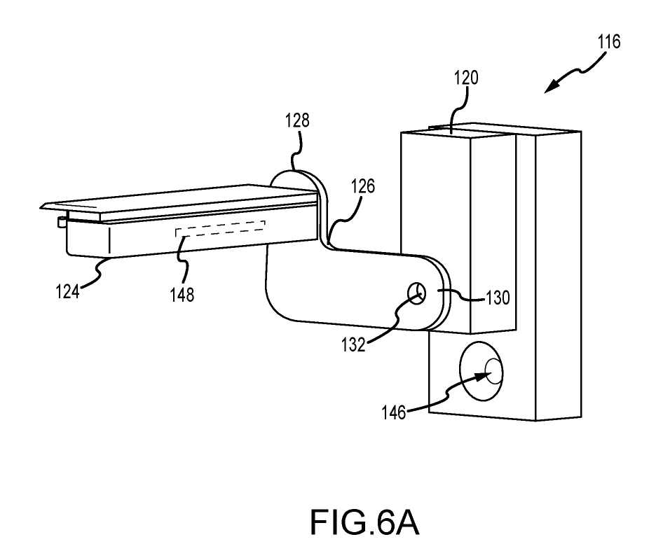

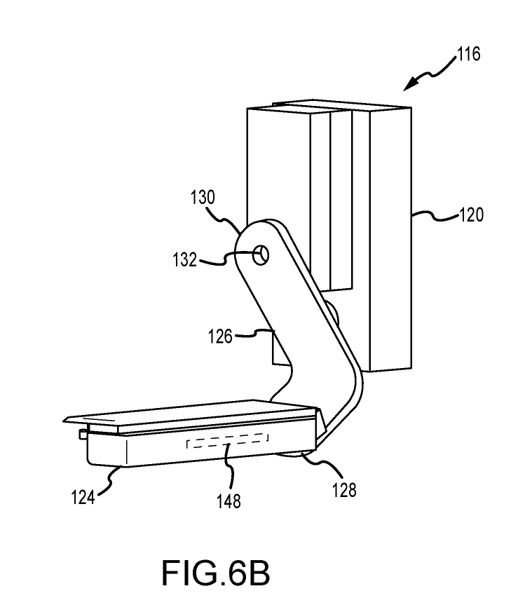

FIG. 4 is a perspective view of the mounting bracket 120 of the sash tilt system 116 (shown in FIG. 3). The mounting bracket 120 includes a jamb portion 134 that is sized and shaped to be received and mounted within the lower sash jamb pocket 122. A sash link portion 136 extends from the jamb portion 134 and is positioned out of the jamb pocket 122. A receiver 138 is defined in the sash link portion 136 for rotatably receiving the post 132 of the sash link 126. The receiver 138 is open at the bottom so that the post 132 can be inserted into the receiver 138 during installation. For example, the sash link 126 is rotated about the sleeve so that the post 132 is inserted into the receiver 138. Below the receiver 138 a keeper link recess 140 is defined that corresponds to a keeper link 142 (shown in FIG. 5) that secures the post 132 within the receiver 138.

FIG. 5 is a bottom perspective view of the sash tilt system 116 shown in FIG. 3. The keeper link 142 is releasably secured to the mounting bracket 120 so as to prevent the post 132 of the sash link 126 from falling downward and out of the receiver 138. The keeper link 142 is substantially C-shaped and has a hook 144 at one end that snap-fits within the keeper link recess 140 to lock the sash link 126 in place. A top portion of the keeper link 142 is positioned adjacent to the post 132 of the sash link 126 so as to restrict movement out of the receiver 138 while still allowing rotational movement. In alternative embodiments, the keeper link 142 is secured within the recess 140 by any other means including, but not limited to, threaded fasteners, resilient press fit connections, adhesives, etc. Additionally, removal of the keeper link 142 allows the post 132 to be removed from the mounting bracket 120, thus enabling the upper sash 104 to be pivoted further away from the window jamb 102, so as to enable easy cleaning of exterior sash surfaces.

FIGS. 6A-6C are perspective views of the sash tilt system 116 in a closed position, a middle position, and a tilted position, respectively. FIGS. 6A-6C are described generally concurrently, and the window jamb and sash are removed for clarity. FIG. 6A depicts the sash tilt system 116 in a first extreme position (the closed position), while FIG. 6C depicts the sash tilt system 116 in a second extreme position (the tilted position). As the sash tilt system 116 moves in an arcuate motion between these extreme positions depicted in FIGS. 6A and 6C, the posts 132, 148 at each end of the sash link 126 rotate in their respective receiving elements.

As illustrated in FIG. 6A, the sleeve 124 is offset from the mounting bracket 120 that extends into the lower sash jamb pocket (not shown) and mounted therein, via a fastener opening 146. As such, the upper sash will be in the closed position with the sash balance providing the lifting forces to maintain the upper sash in a top position within the window jamb. In the closed position, the lower sash may be locked with respect to the upper sash via the sash lock. When the upper sash is desired to be tilted (e.g., for ventilation) the upper sash is pulled in a downward direction so that the sash balance is extended. In an example, the downward travel of the upper sash may be about 2 inches and is determined by the long leg of the L-shaped sash link 126. At the same time, the top rail is pulled toward the lower sash so that the sash link 126 rotates counter-clockwise. As illustrated in FIG. 6B, the sleeve 124 and thus the upper sash is positioned lower than in the closed position and the sleeve 124 is in line with the mounting bracket 120 so that the top rail of the upper sash is moved within the window jamb and the upper sash is beginning to tilt in an inward direction.

As the sleeve 124 is rotated to the tilted position depicted in FIG. 6C, the sash balance returns the upper sash to approximately the same height as in the closed position and the sash tilt system 116 maintains the tilting configuration of the upper sash out of the window jamb. As illustrated in FIG. 6C, the sleeve 124 is offset in the opposite direction from the mounting bracket 120 so that the top rail is positioned outside of the window jamb and the upper sash is in the tilted positon. Additionally, because the upper sash is returned to a height similar to that when in the closed position, the sash lock on the lower sash may still be operable to re-engage and lock the double hung window while in the tilted position. To close the upper sash, the tilting process is then reversed.

The complete range of motion of the sash tilt system 116 may be as required or desired for a particular application, and may be measured by the amount of rotation of the post 132 connected to the mounting bracket 120. In examples, the range of motion may be up to about 90°, up to about 135°, up to about 180°, and greater than 180°. The range of motion may be affected by the configuration and/or length of the sash link 126, the mounting height of the mounting bracket 120 within the jamb pocket, the height of the upper window sash, and other factors. Additionally, the range of motion may be configured so as to not contact the outside screen (not shown) of the double hung window.

FIG. 7 is a perspective view of an exemplary spring balance assembly 200 for the double hung window. The balance assembly 200 is an extension spring-type balance with an anchor bracket 202 at one end and to a sash shoe 204 at the other end. The anchor bracket 202 includes a fastener opening 206 so that the anchor bracket 202 can be mounted within the upper sash jamb pocket. The mounting position of the anchor bracket 202 enables the balancing spring force of the balance assembly 200 to slightly exceed the sash weight when the upper sash is in the closed position and provide a secure closing fit. The sash shoe 204 includes a hook 208 so that the sash shoe 204 can attached to a pivot bar (not shown) extending from the upper sash. The hook 208 also enables the upper sash to pivot and the top rail to tilt away from the window jamb in the tilted position as described above. An extension spring 210 extends between the anchor bracket 202 and the sash shoe 204 and provides the balancing force for the upper sash. In the example, the extension spring 210 is short-travel and spring only that is enabled for short travels distances because the upper sash only vertically moves about 2 inches during the tilting of the sash. In some examples, the extension spring 210 can be disposed at least partially within a sleeve 212 so that spring noise is reduced. The balance assembly 200 is sized to fit into the window jamb. In alternative examples, the balance assembly 200 may be a constant force or spiral balance for use along with the sash tilt system.

FIG. 8 is a flowchart illustrating a method 300 of operating a double hung window. To operate the upper sash in a pivoting/tilting motion, the sash is first unlocked (operation 302). The upper sash can then be pulled down (operation 304) and (at the same time) the top rail of the upper sash is pulled toward the interior of the window (operation 306). This combined motion results in an arcuate motion of the top rail of the upper sash. The top rail of the sash travels through its complete arc and ends at a height approximately equal to the height of the sash in the fully closed position. The sash lock may then be re-engaged (operation 308). The lower sash is securely locked in the closed position and the upper sash is locked in a tilted position giving a venting gap at the top of the sash. If used, the outside screen is not disturbed by the operation of the sash. To close the tilt-in upper sash, the above steps are completed in reverse.

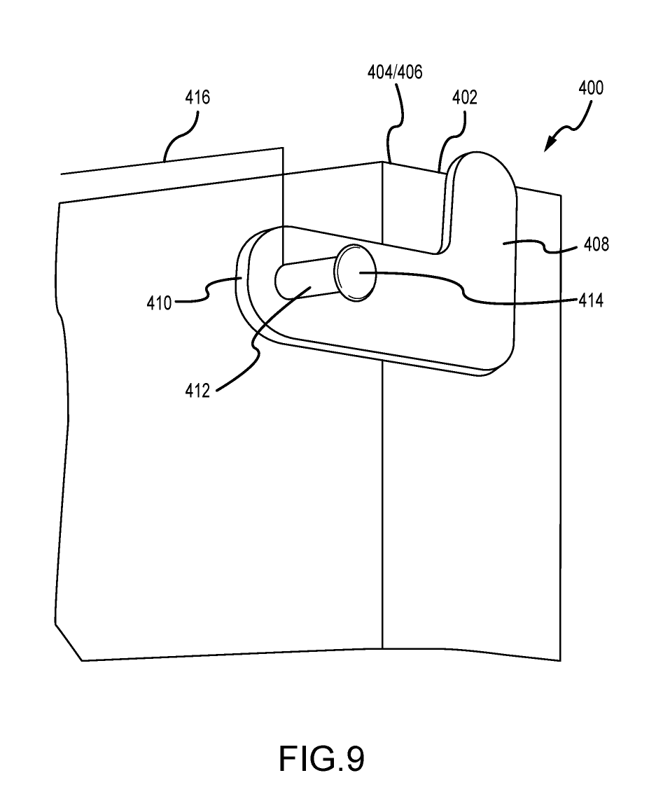

FIG. 9 is a schematic perspective view of another sash tilt system 400. In this example, the sash tilt system 400 includes a sleeve 402 positioned on a top rail 404 of an upper sash 406, a sash link 408 rotatably coupled to the sleeve 402, and a mounting bracket (not shown) that is mounted within the window jamb. A second end 410 of the sash link 408 includes a post 412 so that the sash link 408 is rotatably coupled to the mounting bracket. The post 412 can include an enlarged free end so as to enable the post 412 to be rotatably secured within the mounting bracket as described above. However, in this example, tilting the upper sash 406 may be automated by a motor 414. A torsion bar 416 extends between each sash link 408 and is coupled to the motor 414. The motor 414 can drive a rotation of the torsion bar 416 so as to rotate the sash link 408 and tilt and close the upper sash 406. Thorough use of the motor 414 the upper sash 406 can be tilted remotely, for example, for ventilation purposes. In alternative examples, the torsion bar 416 only couples to one sash link 408 to facilitate movement.

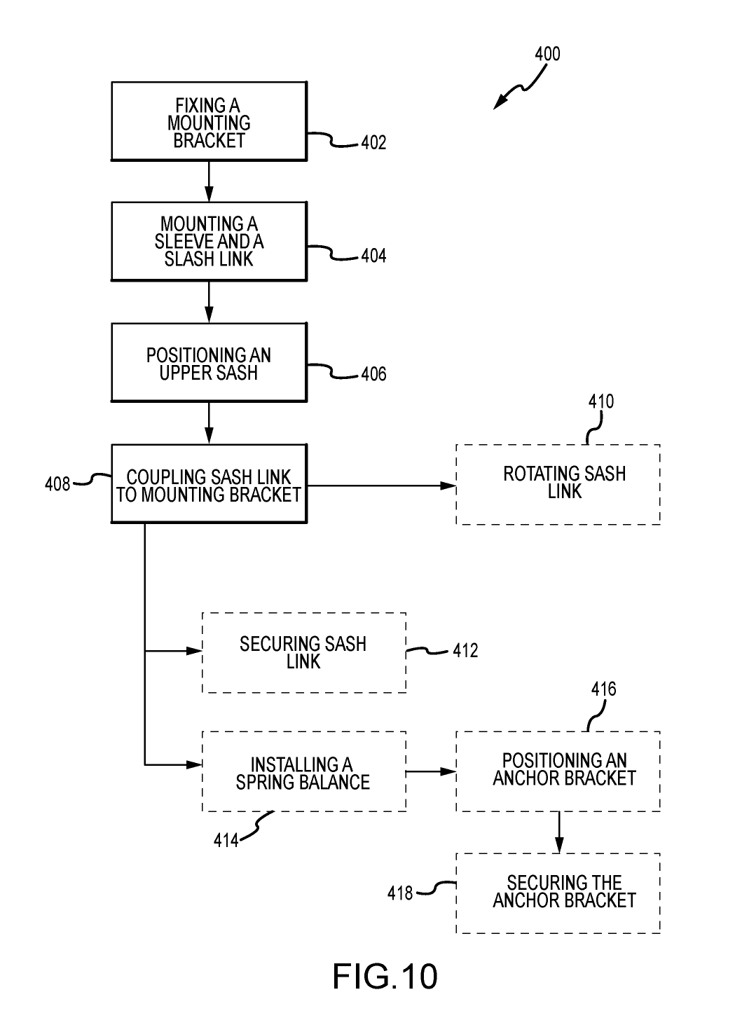

FIG. 10 is a flowchart illustrating a method 500 of assembling a double hung window. The method 500 includes fixing a mounting bracket relative to a lower sash jamb pocket (operation 502). For example, both left and right mounting brackets are mounted in the top of the lower sash frame pockets. A sleeve having a sash link rotatably coupled thereto is mounted to an upper sash (operation 504). For example, both left and right sleeves and sash links are installed along the tilt-latch route in the top of the top rail. The upper sash is positioned into the window jamb with the loosely attached sash links facing the room side of the upper sash so that the upper sash and the sleeve is adjacent to the mounting bracket (operation 506). Once the upper sash is within the window jamb, the sash link is then coupled to the mounting bracket (operation 508). For example, the sash links are rotated toward the mounting bracket such that a post is at least partially received therein (operation 510).

When the sash link is coupled to the mounting bracket, the sash link is secured to the mounting bracket via a keeper link that is snapped into place to retain the sash links (operation 512). The method 500 may also include installing a spring balance on the upper sash (operation 514). Installing the spring balance can include positioning an anchor bracket within an upper sash jamb pocket based on a weight of the upper sash (operation 516), and securing the anchor bracket within the upper sash jamb pocket (operation 518). For example, based on the weight of the upper sash, the mounting position of the anchor bracket is determined by locating the distance from the bottom of the upper sash that is required for mounting the anchor bracket and balancing the upper sash in the correct position. The spring balance may then be disposed within the window jamb so that the spring is biased toward the room side of the window jamb. Additionally, a sash shoe can be pivotably coupled to the upper sash.

The materials utilized in the double hung windows described herein may be those typically utilized for window and window component manufacture. Material selection for most of the components may be based on the proposed use of the window. Appropriate materials may be selected for the double hung windows used on particularly heavy window sashes, as well as on windows subject to certain environmental conditions (e.g., moisture, corrosive atmospheres, etc.). Aluminum, steel, stainless steel, or composite materials can be utilized. Plastics may also be utilized.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A sash tilt system for an upper sash of a double hung window, the sash tilt system comprising:
a mounting bracket sized and shaped to be fixed relative to a lower sash jamb pocket;
a sleeve configured to be mounted on the upper sash; and
a sash link comprising a first end and an opposite second end, wherein the first end is rotatably coupled to the sleeve and the second end comprises a post extending therefrom, wherein the post is at least partially receivable within the mounting bracket such that the sash link is rotatable with respect to the mounting bracket and the sleeve when the upper sash tilts away from an upper sash jamb pocket.

2. The sash tilt system of claim 1 further comprising a keeper link configured to rotatably secure the post at least partially within the mounting bracket.

3. The sash tilt system of claim 1 further comprising a spring balance assembly disposed within the upper sash jamb pocket configured to balance the upper sash.

4. The sash tilt system of claim 3, wherein the spring balance assembly comprises:
an extension spring;
an anchor bracket disposed on one end of the extension spring, the anchor bracket configured to secure within the upper sash jamb pocket; and
a shoe disposed on an opposite end of the extension spring, the shoe configured to couple to the upper sash.

5. The sash tilt system of claim 1, wherein the sash link is substantially L-shaped.

6. The sash tilt system of claim 1 further comprising a motor coupled to the sash link, wherein the rotation of the sash link is driven by the motor.

7. A double hung window comprising:
an upper sash disposed at an upper sash jamb pocket;
a lower sash disposed at a lower sash jamb pocket;
at least one sash tilt system configured to tilt the upper sash in relation to the upper sash jamb pocket, the at least one sash tilt system comprising:
a mounting bracket fixed relative to the lower sash jamb pocket;
a sleeve mounted to the upper sash; and
a sash link extending between the mounting bracket and the sleeve, wherein the sash link is rotatable in relation to the mounting bracket and the sleeve when the upper sash tilts.

8. The double hung window of claim 7, wherein the sash link comprises a post that is at least partially rotatably receivable within the mounting bracket.

9. The double hung window of claim 8 further comprising a keeper link configured to rotatably secure the post at least partially within the mounting bracket.

10. The double hung window of claim 7 further comprising at least one spring balance disposed within the upper sash jamb pocket.

11. The double hung window of claim 10, wherein the at least one spring balance comprises:
an anchor bracket secured within the upper sash jamb pocket;
a shoe coupled to the upper sash; and
an extension spring extending between the anchor bracket and the shoe.

12. The double hung window of claim 11, wherein the extension spring is disposed within a spring sleeve.

13. The double hung window of claim 7, wherein the sleeve is mounted on a top rail of the upper sash.

14. The double hung window of claim 7, wherein the at least one sash tilt system comprises a first sash tilt system disposed on a first side of the upper sash and a second sash tilt system disposed on a second side of the upper sash, and wherein the double hung window further comprises:
a torsion bar extending between the first tilt assembly and the second tilt assembly; and
a motor configured to drive the torsion bar and tilt the upper sash.

15. The double hung window of claim 7 further comprising a sash lock disposed on the lower sash.

16. A method of assembling a double hung window comprising:
fixing a mounting bracket relative to a lower sash jamb pocket;
mounting a sleeve having a sash link to an upper sash;
positioning the upper sash and the sleeve adjacent to the mounting bracket; and
coupling the sash link to the mounting bracket.

17. The method of claim 16 further comprising securing the sash link to the mounting bracket via a keeper link.

18. The method of claim 16 further comprising installing a spring balance on the upper sash.

19. The method of claim 18, wherein installing the spring balance further comprises:
positioning an anchor bracket within an upper sash jamb pocket based on a weight of the upper sash; and
securing the anchor bracket within the upper sash jamb pocket.

20. The method of claim 16, wherein coupling the sash link to the mounting bracket further comprises rotating the sash link towards the mounting bracket such that a post is at least partially received therein.
